(19) United States
(12) Patent Application Publication
(10) Pub. No.: US 2011/0301968 A1
(43) Pub. Date: Dec. 8, 2011

(54) Methods, Systems and Computer Program Products for Providing Targeted Displays for Pharmacy Signature Capture Systems

(76) Inventors: Sharen Ann Godwin, Wilmington, NC (US); Frank Phillip Sheppard, Raleigh, NC (US)

(21) Appl. No.: 13/102,570

(22) Filed: May 6, 2011

Related U.S. Application Data
(63) Continuation-in-part of application No. 11/375,516, filed on Mar. 14, 2006.
Application No. 11/375,516 is a continuation-in-part of application No. 12/494,651, filed on Jun. 30, 2009.

(51) Int. Cl. G06Q 50/00; G06Q 10/00

(52) U.S. Cl. 705/2

(57) ABSTRACT

A pharmacy signature capture system can display a targeted message for playing to a signor using criteria that are based on a prescription number that is provided during a pharmacy transaction. The functionality of a signature capture system can thereby be enhanced to provide targeted educational messages concerning the pharmaceutical prescription, targeted messages that indicate alternative medications that may substituted for the pharmaceutical prescription, targeted messages that identify other items that may be desired, targeted messages that solicit participation in a study related to the pharmaceutical prescription and/or other targeted messages. Related systems and computer program products are also discussed.

### RELATED APPLICATIONS

This application is a continuation-in-part application of and claims priority to U.S. application Ser. No. 11/375,516, filed Mar. 14, 2006, and U.S. application Ser. No. 12/494,651, filed Jun. 30, 2009, which in turn claims priority to U.S. Pat. No. 7,558,380, filed Sep. 25, 2003, the disclosures of each of which are hereby incorporated by reference in their entireties.

### FIELD OF THE INVENTION

This invention relates to pharmacy management systems, methods and/or computer program products, and more specifically to signature capture systems, methods and/or computer program products that are used in pharmacies.

### BACKGROUND OF THE INVENTION

Pharmacy management systems, methods and/or computer program products are widely used to run a pharmacy such as a stand-alone pharmacy and/or a pharmacy department of a larger establishment. Pharmacy management systems can handle management aspects of the pharmacy including management aspects of dispensing pharmaceutical prescriptions. Pharmacy management systems may also include an interactive voice response (IVR) system that can allow callers to access the pharmacy services by telephone when the pharmacy is open and/or when the pharmacy is closed. As is well known to those having skill in the art, a pharmacy management system, method and/or computer program product can operate on one or more stand-alone or networked computers and/or can be installed on one or more computers that provides other general functions.

Pharmacy management systems often include a signature capture system that is used to capture a signature that is associated with the dispensing of a pharmaceutical prescription. The signature may be captured to acknowledge pharmaceutical prescription receipt, to acknowledge Health Insurance Privacy and Portability Act (HIPPA) information receipt and/or for other purposes. Signature capture systems typically include a signature capture touch screen that may be “written on” using a stylus and/or special pen. The signature capture touch screen may also include a series of touch screen buttons that may be pressed with a finger and/or stylus to indicate completion of the signature and/or other user selections. A series of screens may be displayed and a series of user inputs may be accepted by the signature capture system. The signature capture system may include a single display for accepting signatures and/or other user inputs and for displaying user instructions and/or information. Alternatively, one or more additional displays may be provided to display additional information. Moreover, the signature capture display(s) may be dedicated displays and/or may be multifunction displays that may be used to perform other functions in the pharmacy management system. The design and operation of signature capture systems and the design of and operation of signature capture systems for use with pharmacy management systems are well known to those having skill in the art and need not be described further herein.

### SUMMARY OF THE INVENTION

Some embodiments of the present invention operate a pharmacy in response to accepting a signature on a signature capture system during a pharmacy transaction, by identifying a targeted message for display on the signature capture system using predefined criteria that are based on an identification of a pharmaceutical prescription that is associated with the signature that is accepted. Accordingly, embodiments of the invention can allow a signature capture system to deliver targeted messages to users based on predefined criteria that are based on identification of a pharmaceutical prescription that is associated with the transaction. The functionality of a conventional signature capture system may be enhanced to provide targeted educational (including promotional) messages concerning the pharmaceutical prescription, targeted messages that indicate alternative medications that may be substituted for the pharmaceutical prescription, targeted messages that identify other items such as medications or supplies that may be desired, targeted messages that solicit participation in a study and/or survey related to the pharmaceutical prescription and/or other targeted messages, based on the specific pharmaceutical prescription that is associated with the signature that is captured and is being used by the signor or a party related to the signor for whom the signor has signed.

In some embodiments of the present invention, an identification of a pharmaceutical prescription (e.g., prescription number) is accepted during a pharmacy transaction. The identification may be validated. The pharmaceutical prescription may be identified by a bar code scan of a bar code on a container that corresponds to the pharmaceutical prescription, by input at a keyboard and/or other input device of the pharmaceutical prescription number that corresponds to the pharmaceutical prescription and/or by inputting identification information that can be used to identify the pharmaceutical prescription, during the pharmacy transaction. A signature is accepted on a signature capture system during the pharmacy transaction. The signature may be stored. The signature may be accepted to acknowledge pharmaceutical prescription receipt, to acknowledge HIPPA information receipt, to confirm credit card/debit card payment for the pharmaceutical prescription and/or to acknowledge a desire to receive the targeted message. At least one database is then queried using predefined criteria based on the identification of a pharmaceutical prescription to identify a targeted message. The database may include a rules engine. The targeted message is then displayed on the signature capture system during the pharmacy transaction.

In some embodiments, the signature capture system includes a signature capture touch screen and the targeted message is displayed on the signature capture touch screen. In other embodiments, an instruction screen also may be provided and the targeted message is displayed on the signature capture touch screen and/or on the instruction screen. Moreover, the targeted message may be removed from display on the signature capture system after expiration of a timer. In some embodiments, a series of user responses may be accepted at the signature capture system and a series of targeted messages may be displayed to provide a desired prompt/response and/or information display flow. In still other embodiments, a response to the targeted message is received and, in still other embodiments, the response and/or other events are logged. In still further embodiments, the pharmacy is instructed to perform an action in response to the response to the targeted display(s).

In some embodiments, querying is performed by querying at least one pharmacy dispensing system database using the identification of the pharmaceutical prescription to identify the predetermined criteria. At least one message database is then queried using the predetermined criteria to identify a targeted message(s).

In some embodiments, the predefined criteria based on the identification of a pharmaceutical prescription include age of a patient, a gender of the patient, medication of the pharmaceutical prescription, last fill date of the pharmaceutical prescription, days supply on last fill of the pharmaceutical prescription, original fill date of the pharmaceutical prescription, disease state of the patient, physician of the patient and/or other promotions that are in effect. In some embodiments, the predefined criteria do not include a personal identification of the patient, for privacy and/or other reasons. It will be understood that, as used herein, “patient” refers to the user of the pharmaceutical prescription, who may be the signor in some circumstances, but who also may be a parent, child, relative or friend of the signor in other circumstances.

In some embodiments, querying is performed by querying at least one database using one or more of the above-described predefined criteria. A targeted message is identified that corresponds to the age of the patient, gender of the patient, medication of the pharmaceutical prescription, last fill date of the pharmaceutical prescription, days supply on last fill of the pharmaceutical prescription, original fill date of the pharmaceutical prescription, disease state of the patient, physician of the patient and/or other promotions in effect. If more than one targeted message satisfies the predefined criteria, the messages may be prioritized in some embodiments.

In some embodiments, at least one database is queried using the predefined criteria based on the identification of the pharmaceutical prescription, to identify an educational (informational) targeted message related to the pharmaceutical prescription. For example, at least one database is queried to determine whether days supply on last fill date exceeds a threshold and an educational targeted message may be provided that reminds the caller how to use the pharmaceutical prescription if the days supply on last fill date exceeds the threshold.

In other embodiments, if the last fill date is less than a first threshold and the days supply on last fill date exceed a second threshold, then a targeted message may be provided that indicates alternative medications that may be substituted for the pharmaceutical prescription. In still other embodiments, if the last fill date is less than a first threshold and the days supply on last fill date exceed a second threshold, then a targeted message may be provided that indicates other items, such as related medications or supplies, that may be desired by the patient. In these embodiments, the first threshold may be equal or unequal to the second threshold. Finally, in still other embodiments, a determination is made as to whether the age of the patient qualifies the patient to participate in a study related to the pharmaceutical prescription, and a targeted message is provided that solicits participation of the patient in the study, if the age of the patient qualifies the caller to participate. The study can include any type of conventional study or surveys including post-market surveys and medication use surveys.

It will be understood that although the above description has focused primarily on method aspects, other embodiments of the present invention may provide pharmacy management systems, methods for operating a pharmacy signature capture system and/or computer program products for operating a pharmacy management/signature capture system. Moreover, other embodiments of the present invention may be employed in a non-pharmacy environment, wherein targeted messages may be provided on a signature capture system based on an identification other than a pharmaceutical prescription, such as an employee number, a Social Security number, a credit card number, a zip code and/or an insurance identification number, using predefined criteria based on the user input to identify a targeted message. For example, in the retail environment, wherein a scanner is used to scan barcodes on goods, a signature capture may be used to obtain a credit card/debit card authorization for the purchase of goods. A targeted message may be provided on the signature capture system based on an identification of the purchaser from the purchaser's credit card/debit card information.

### BRIEF DESCRIPTION OF THE DRAWINGS

FIG. 1 is a block diagram of systems, methods and/or computer program products for providing targeted messages in a pharmacy according to some embodiments of the present invention.

FIGS. 2 and 3 are flowcharts of operations that may be performed to provide targeted messages according to some embodiments of the present invention.

FIGS. 4A and 4B are block diagrams of systems, methods and/or computer program products for providing targeted messages in a pharmacy according to other embodiments of the present invention.

FIG. 5 is a flowchart of operations that may be performed to provide targeted messages according to some embodiments of the present invention.

FIGS. 6 and 7 are flowcharts that illustrate various combinations of predetermined criteria that may be used to identify targeted messages according to various embodiments of the present invention.

FIGS. 8-11 are flowcharts that illustrate examples of operations that may be performed to provide targeted messages according to various embodiments of the present invention.

FIG. 12 is a flowchart of operations that may be performed to provide targeted messages according to yet other embodiments of the present invention.

FIGS. 13A-13C illustrate attributes that may be used to identify a targeted message according to some embodiments of the present invention.

FIGS. 14A-14D are screen shots of targeted message screens that may be displayed on a signature capture system according to some embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items and may be abbreviated as “/”. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The present invention is described below with reference to block diagrams and/or flowchart illustrations of methods, apparatus (systems) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block may be separated into multiple blocks and/or the functionality of two or more blocks may be at least partially integrated.

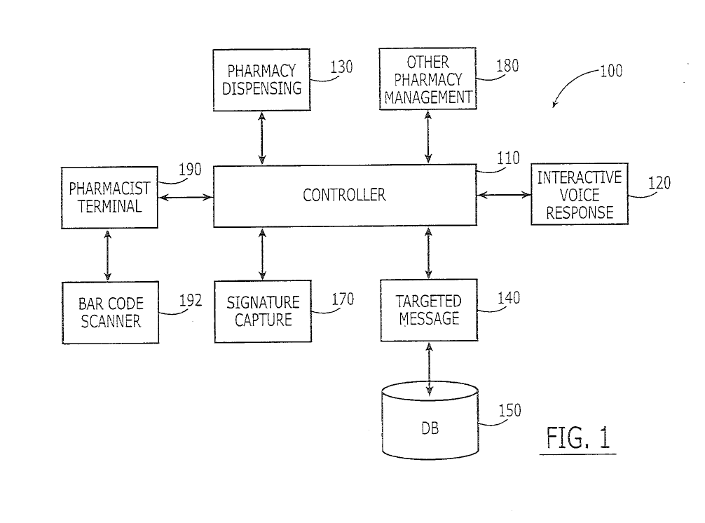

FIG. 1 is a block diagram of systems, methods and/or computer program products for operating a pharmacy according to some embodiments of the invention. As shown in FIG. 1, these pharmacy operating systems, methods and/or computer program products include a controller 110, a targeted message module 140, a database 150 and a signature capture system 170. A pharmacy dispensing module 130, an Interactive Voice Response (IVR) system 120 and/or other pharmacy management modules 180 also may be included. The controller 110 may be embodied as one or more enterprise, application, personal and/or pervasive computer systems which may be connected by a network such as a local area network and/or a wide area network including the Internet. The controller 110 can coordinate interaction among the other components of FIG. 1. It will be understood that the functionality of the controller 110 can be centralized and/or distributed among the other components.

The IVR system components 120 may be coupled to one or more telephone lines to receive telephone calls from callers. The IVR system 120 can include prerecorded voice prompts such as prerecorded human voice segments, stored text-to-speech generated segments, text-to-speech segments that are generated on the fly, and/or use other conventional techniques for generating voice prompts. The pharmacy dispensing system 130 may be used to manage patient records, manage doctor records, manage medication data, facilitate prescription fulfillment and/or perform other functions. Other pharmacy management systems 180 may be used to perform other pharmacy management functions.

The design and operation of the IVR system 120, pharmacy dispensing system 130 and other pharmacy management systems 180 are well known to those having skill in the art and need not be described further herein. Moreover, it will be understood that the IVR system 120, the pharmacy dispensing system 130 and/or the other pharmacy management systems 180 may be combined to run on a single enterprise, application and/or personal computer system. Alternatively, these systems may be distributed over more than one enterprise, application, personal and/or pervasive computer systems which may be connected by a network such as a local network and/or a wide area network including the Internet.

Still referring to FIG. 1, a pharmacist terminal 190 may be used by a pharmacist to perform pharmacist functions in the pharmacy. A barcode scanner 192 also may be included and may be used by the pharmacist to identify a pharmaceutical prescription by scanning a barcode on a container (a bag, box, bottle, etc.) that corresponds to the pharmaceutical prescription. The design and operation of a pharmacy terminal 190 and a barcode scanner 192 are well known to those having skill in the art and need not be described further herein.

Still referring to FIG. 1, a targeted message module 140 is provided according to some embodiments of the present invention. The targeted message module 140 may comprise hardware and/or software. The targeted message module 140 is configured to identify a targeted message for displaying on the signature capture system 170 using predefined criteria that are based on an identification of a pharmaceutical prescription. The predefined criteria for identifying a targeted message may be stored in at least one database 150 as will be described in detail below. It will be understood by those having skill in the art that the targeted message module 140 and/or database 150 may be integrated within one or more of the other components of the pharmacy system 100, in some embodiments. In other embodiments, the targeted message module 140 and/or database 150 may be provided on one or more enterprise, application, personal and/or pervasive computer systems that may be connected to one another using a network such as a local area network and/or a wide area network including the Internet. It will be understood by those having skill in the art that the term “database” is used herein to generically represent any kind of querying system, such as a rules engine, table, neural network, etc.

The signature capture system 170 may include one or more touch screen displays that are configured to accept a signature using a stylus and/or other device and may also include one or more keys and/or buttons (fixed and/or programmable) that may be activated by a user, for example, using a stylus and/or finger, to provide various user inputs. Various sequences of display screens may be displayed and user inputs may be accepted to provide prompt/response and/or information to a user of the signature capture system. The overall design of a signature capture system is well known to those having skill in the art and need not be described further herein.

Pharmacy operating systems, methods and/or computer program products according to some embodiments of the present invention may operate in response to accepting a signature on a signature capture system, such as the signature capture system 170 of FIG. 1, during a pharmacy transaction. A targeted message is identified, for example by the targeted message system 140, for display on the signature capture system 170, using predefined criteria that are based on an identification of a pharmaceutical prescription that is associated with the signature that is accepted. Accordingly, a point-of-signature capture may be used to provide targeted message displays to the user who is providing a signature, also referred to herein as a “signor”.

Systems, methods and/or computer program products according to embodiments of the present invention can provide the pharmacy and/or other interested parties an ability to display targeted informational messages, targeted promotional messages, targeted surveys and/or other targeted messages to users who are providing a signature during a pharmacy transaction. In some embodiments, a targeted message may be identified for displaying to the user using predefined criteria that are based on identification of the pharmaceutical prescription related to the user. In some embodiments, the pharmacy system may have access to specific patient data through the pharmacy dispensing system 130, based on the identification of the pharmaceutical prescription. Using this data, the targeted message module 140 may retrieve various predefined identifiers that indicate signors as candidates for display of a specific targeted message that may directly relate to their prescription. If a patient meets a set of identified criteria that matches a targeted message, the targeted message module 140 can display the message(s) and gather any responses through the signature capture system 170. It will be understood by those having skill in the art that a message can include a single displayed message, a series of displayed messages, or a complex message flow.

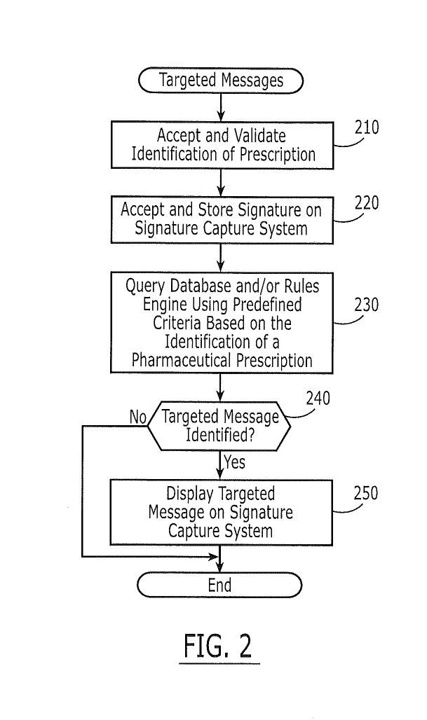

FIG. 2 is a flowchart of operations that may be performed to provide targeted messages according to some embodiments of the present invention. These operations may be provided, for example, by the targeted message module 140 of FIG. 1, using the signature capture system 170 and/or other components of FIG. 1.

Referring now to FIG. 2, at Block 210, an identification of a pharmaceutical prescription is accepted during a pharmacy transaction. The identification of a pharmaceutical prescription generally is a prescription number (“Rx number”) which may be provided at various times during the pharmacy transaction. For example, when the prescription is being filled, a barcode scan of a barcode on a container that corresponds to the pharmaceutical prescription may be accepted. The barcode scan may be performed by a pharmacist, a pharmacy clerk and/or other employee using the pharmacist terminal 190 and/or barcode scanner 192. Alternatively, at various points during the pharmacy transaction, the pharmaceutical prescription number (Rx number) may itself be input by a pharmacist and/or clerk using a keyboard and/or other input device at the pharmacist terminal 190 and/or another terminal. In still other embodiments, the pharmaceutical prescription number itself is not directly input but rather identification information such as the patient's last name is input, which can be used to identify the pharmaceutical prescription as part of the pharmacy transaction. The identification of a pharmaceutical prescription as part of a pharmacy transaction, and the various times during a pharmacy transaction when such an identification may be accepted, are well known to those having skill in the art and need not be described further herein. Moreover, in some embodiments, the identification of the prescription may be validated, using techniques well known to those having skill in the art.

Still referring to FIG. 2, at Block 220, a signature is accepted on a signature capture system during the pharmacy transaction. The signature may be accepted at one or more points during the pharmacy transaction. For example, a signature may be accepted to acknowledge receipt of the pharmaceutical prescription, to acknowledge HIPPA information receipt and/or to confirm credit card/debit card payment. In other embodiments the signature may be accepted as part of a prompt asking the user as to whether the user desires to receive a targeted message. More than one signature may be accepted. The capturing of the signature during a pharmacy transaction is well known to those having skill in the art and need not be described further herein. In some embodiments, the captured signature may be stored for archival purposes, using techniques known to those having skill in the art. Moreover, it will also be understood that the operations of Blocks 210 and 220 may be performed in the order shown in FIG. 2, at least partially concurrently, or the operations of Block 210 may be performed at least partially after a signature capture of Block 220.

It will also be understood that the signor of the signature capture system may be the patient (i.e., the user of the medication of the pharmaceutical prescription) or the signor may be someone who is signing on behalf of the patient such as a relative or friend of the patient.

Still referring to FIG. 2, at Block 230, at least one database, such as a database 150 of FIG. 1 and/or a database in the pharmacy dispensing system 130, is queried using predefined criteria based on the identification of a pharmaceutical prescription, to identify a targeted message. It will be understood by those having skill in the art that the term “database” is used herein to generically represent any kind of querying system, such as a rules engine, table, neural network, etc. In some embodiments, the predefined criteria based on identification of a pharmaceutical prescription can comprise age of the patient, gender of the patient, medication of the pharmaceutical prescription, last fill date of the pharmaceutical prescription, days supply on last fill of the pharmaceutical prescription, original fill date of the pharmaceutical prescription, disease state of the patient, physician of the patient and/or other promotions in effect. In other embodiments, the predefined criteria based on identification of a pharmaceutical prescription do not provide a personal identification of the patient for privacy and/or other reasons. In some embodiments, at least one pharmacy dispensing system database, such as at least one database in the pharmacy dispensing system 130, is queried using the identification of the pharmaceutical prescription to identify the predetermined criteria. Then, at least one message database, such as at least one database 150 that is associated with the targeted message module 140, is queried using the predetermined criteria to identify a targeted message to be displayed. It will also be understood that the operations of Block 230 may be performed prior to, at least partially simultaneous with and/or after the operations that are performed at Block 220.

Still referring to FIG. 2, at Block 240, if a targeted message is identified, then the targeted message is displayed on the signature capture system, at Block 250. In some embodiments, prior to displaying the targeted message, an “opt-in” message is displayed, asking whether the patient wishes to opt-in to hear an informational, educational, clinical research study opportunity, etc., message, and upon acceptance, the targeted message is displayed. More specifically, in some embodiments, at Block 240, a targeted message that corresponds to the age of the patient, gender of the patient, medication of the pharmaceutical prescription, last fill date of the pharmaceutical prescription, days supply on last fill of the pharmaceutical prescription, original fill date of the pharmaceutical prescription, disease state of the patient, physician of the patient and/or other promotions in effect, is identified based in the database query. In some embodiments, the targeted message may comprise an educational message concerning the pharmaceutical prescription, a message that indicates alternative medications that may be substituted for the pharmaceutical prescription, a message that identifies other items (related and/or unrelated to the pharmaceutical prescription) that may be desired by the patient and/or a message that solicits participation of the patient in a study related to the pharmaceutical prescription.

The targeted message may be displayed on a signature capture system at Block 250 using many different techniques. For example, some signature capture systems include a signature capture touch screen, and the targeted message is displayed on the signature capture touch screen. An enlarged touch screen may be provided in some embodiments so as to allow an enlarged display of targeted messages. In other embodiments, the signature capture system may include a separate instruction display that may be used to provide instructions for capturing a signature. In these embodiments, the targeted message may be displayed on the signature capture touch screen and/or the instruction display.

Many examples of targeted messages may be provided according to various embodiments of the present invention. For example, a targeted message may include text images (static or moving) in a single display or a series of screen displays. Indeed, any type of multimedia (audio and/or video) message may be displayed on the signature capture system to provide a targeted message to the signor. It will be understood that, in some embodiments, an audio message is not provided along with a displayed message for privacy purposes. From the perspective of the signor, some embodiments of the present invention display a targeted message at Block 250 in response to the signor providing a signature at the signature capture system. Accordingly, the functionality of the signature capture system may be expanded from merely accepting a signature and/or other rudimentary user inputs to providing targeted messages to the user.

Examples of criteria, targeted messages and their generation according to some embodiments of the present invention, will be described in detail below. However, it will be understood by those having skill in the art that these examples of criteria and targeted messages are only exemplary and many other criteria and/or targeted messages may be generated and used according to other embodiments of the present invention.

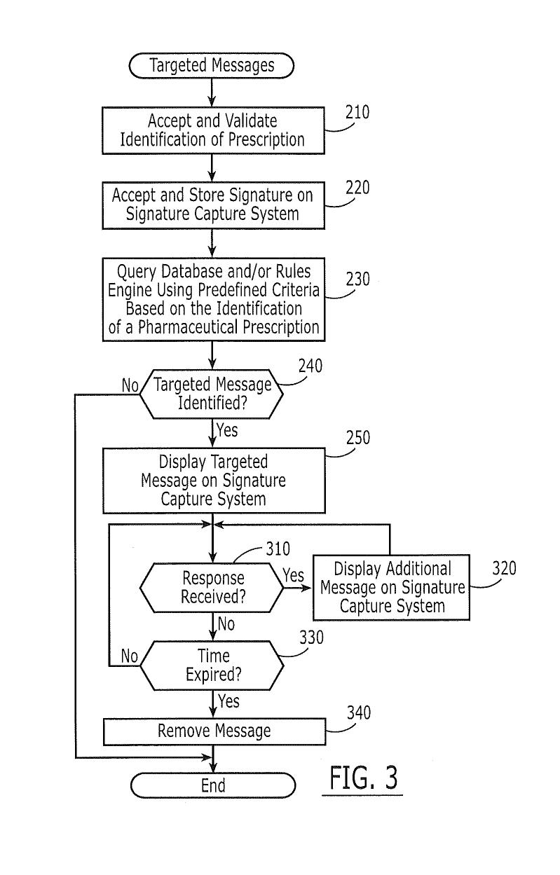

FIG. 3 illustrates operations that may be performed according to other embodiments of the present invention. In FIG. 3, the operations of Blocks 210, 220, 230, 240 and 250 are performed. Then, at Block 310 a test is made as to whether a response is received to the displayed targeted message of Block 250. A response may be received by providing a user input on the signature capture touch screen, on an associated keyboard, voice response system and/or any other conventional user input system that is associated with the signature capture system. If a response is received at Block 310, then at Block 320 additional targeted messages may be displayed on the signature capture system. The additional message may have all of the characteristics of the original message that were described above in connection with Block 250.

Still referring to FIG. 3, if a response is not received at Block 310 and a timer has expired at Block 330 then the message may be removed at Block 340. The message may be removed after expiration of a timer for privacy purposes. In some embodiments, after removing the message, a screen saver is displayed.

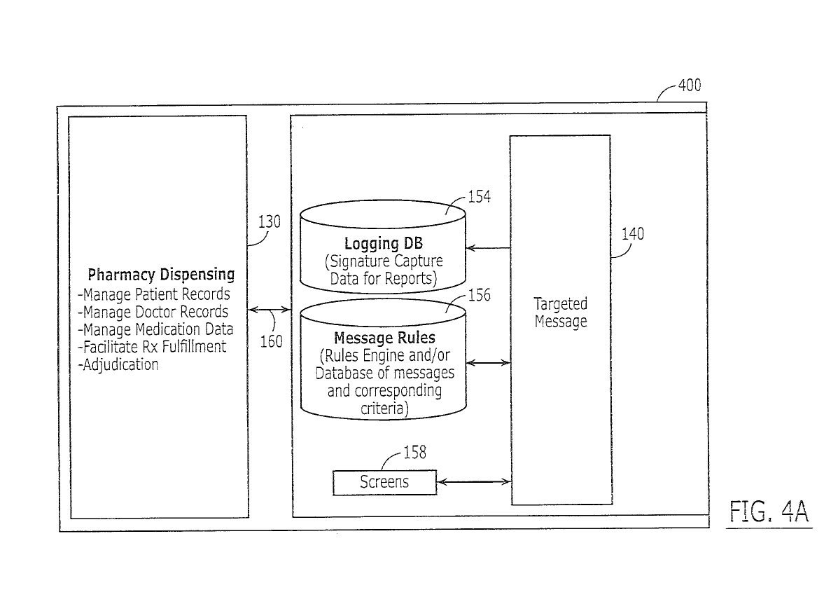

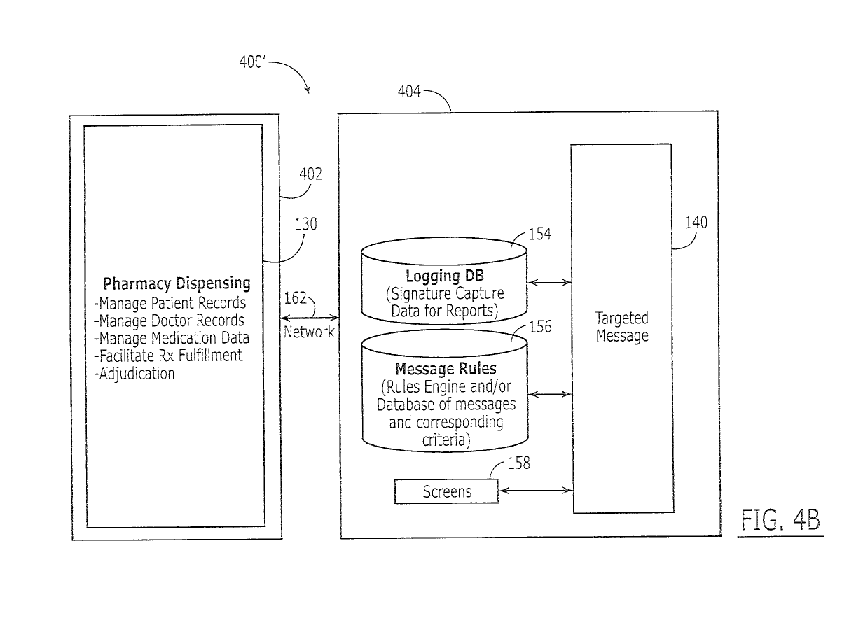

FIGS. 4A and 4B are detailed block diagrams of systems, methods and/or computer program products for providing targeted messages on a pharmacy signature capture system according to other embodiments of the present invention. In FIG. 4A, the pharmacy dispensing system 130 and targeted message system 140 are both included in a single data processing system 400, which may include one or more enterprise, application, personal and/or pervasive computer systems. The targeted message system 140 and the pharmacy dispensing system 130 may be connected by an internal hardware and/or software interface 160. In contrast, in FIG. 4B, the pharmacy dispensing system 130 is contained in a first data processing system 402, and the targeted message system 140 is contained in a second data processing system 404 that are connected by a network 162, which may include a local and/or wide area network including the Internet. Each of the first and second data processing systems 402 and 404, respectively, may include one or more enterprise, application, personal and/or pervasive computer systems.

Still referring to FIGS. 4A and 4B, the pharmacy dispensing system 130 can include functionality for managing patient records, managing doctor records, managing medication data, facilitating prescription (Rx) fulfillment and/or adjudication between the pharmacy and the payer (insurance company). A plurality of databases are shown in FIGS. 4A and 4B. In particular, a logging database 154 may log data and/or other events for reports. A message rules database 156 can store therein messages and corresponding criteria that can trigger a message. It will be understood by those having skill in the art that the term “database” is used herein to generically represent any kind of querying system, such as a rules engine, table, neural network, etc. Finally, a screens database 158 can store therein actual screen images (static and/or moving) that are used for the messages. It will be understood that some or all of the functionality of databases 154-158 may be combined into one or more databases, which may correspond, for example, to the database 150 of FIG. 1. Accordingly, as used herein, a database includes a centralized and/or distributed database.

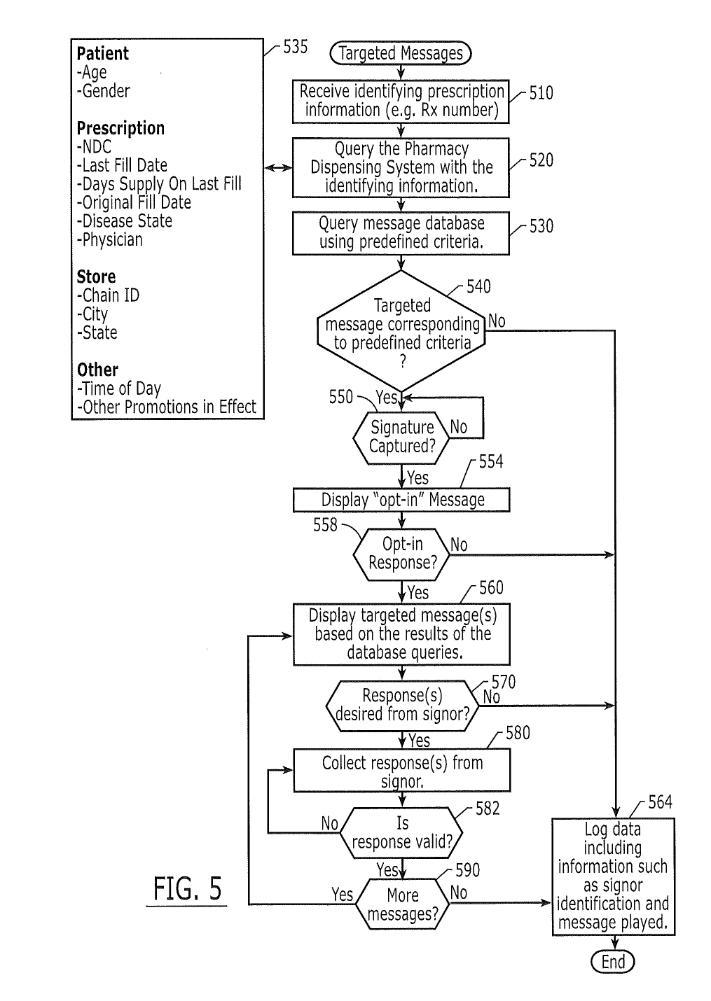

FIG. 5 is a flowchart of operations that may be performed to provide targeted messages according to some embodiments of the present invention. In particular, referring to FIG. 5, at Block 510, the identifying prescription information is received at some point during the pharmacy transaction. As was described above, the identification of a pharmaceutical prescription may be received via a barcode scan at the time the prescription is dispensed and/or at another time, by input of a prescription number by a pharmacist and/or clerk and/or by accepting input of identification information, such as last name, that can be used to identify the pharmaceutical prescription as part of the pharmacy transaction. Then, at Block 520, the pharmacy dispensing system is queried with the identifying information (e.g., pharmaceutical prescription number). As shown at Block 535, the pharmacy dispensing system and/or other system may include one or more patient databases that may include patient age and patient gender. One or more prescription databases may also include information about the pharmaceutical prescription, such as the National Drug Code (NDC) (i.e., the medication of the pharmaceutical prescription), last fill date, days supply on last fill, original fill date, disease state and physician. One or more store databases may also include information on the pharmacy itself, such as a chain ID, city and state. Other databases may include time of day and other promotions that are in effect. It will be understood that combinations and subcombinations of these databases may be merged into one or more databases. Moreover, not all of the fields need be included in the database and/or one or more of the fields may be inferred from other fields. For example, the gender of the patient may be inferred from the medication that is identified. Similarly, a disease state may be inferred from the medication that is identified. At Block 530, the prescription number or other entered information is used to identify predetermined criteria related to the patient or the patient's medication. It will be understood that, in some embodiments, the actual identity of the patient need not be provided, but only information concerning the patient/medication may be identified.

Then, at Block 540, the information that was obtained is compared with a message database, such as a message rules database 156 of FIGS. 4A and 4B, in order to determine which targeted messages may be pertinent and which messages to display. At Block 550, if a targeted message corresponds to, e.g., matches, the predefined criteria based on the prescription number, then at signature capture time during the transaction, targeted messages are displayed based on the results of the database queries. This message is targeted in that it can directly address specific needs or conditions of the user.

If a targeted message corresponding to the predefined criteria is not found at Block 540, then the operations may be continued at Block 564, to log data and/or selected data. Logging may be performed for reporting and/or analysis. Logging data may include identification of the user, messages displayed, date and time, user responses, etc.

Returning to Block 550, if a targeted message is identified at Block 540, a display of a “opt-in” message is provided at Block 554. The display may be an “Opt-In” button and/or a message that indicates a choice of opting in to see the subsequent message. At Block 558, if “Opt-In” is selected, then the targeted messages are displayed, simultaneous with, prior to, and/or after signature capture based on the results of the database queries, at Block 560. If a response is desired from the signor at Block 570, then one or more responses are collected from the signor at Block 580, with standard or other tests being made at Block 582 to validate responses. A response may be desired at Block 570, for example, if the signor is given the option to switch to a different medication or is offered the opportunity to complete a customer survey. A response may be checked for validity at Block 582 by verifying the proper number of characters and/or performing other validation tests.

Finally, at Block 590, if more messages are available, the user is returned to the message portion of the flow (Block 560). If the messages and/or customer action is complete, at Block 590, the messages/responses may be logged at Block 564 and operations can end. It thus will be understood that a single targeted message, a series of related targeted messages or a plurality of unrelated targeted messages may be displayed according to various embodiments of the invention.

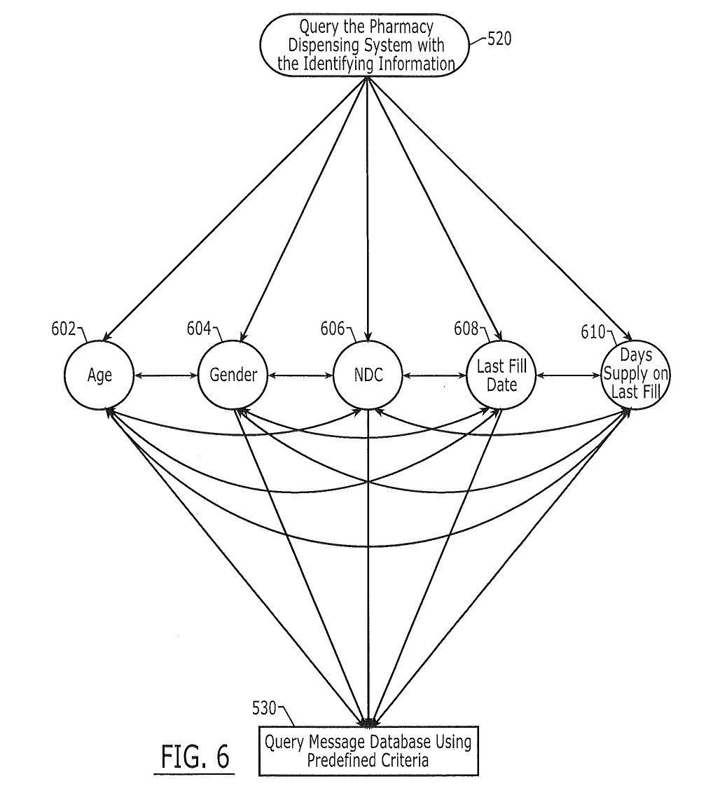

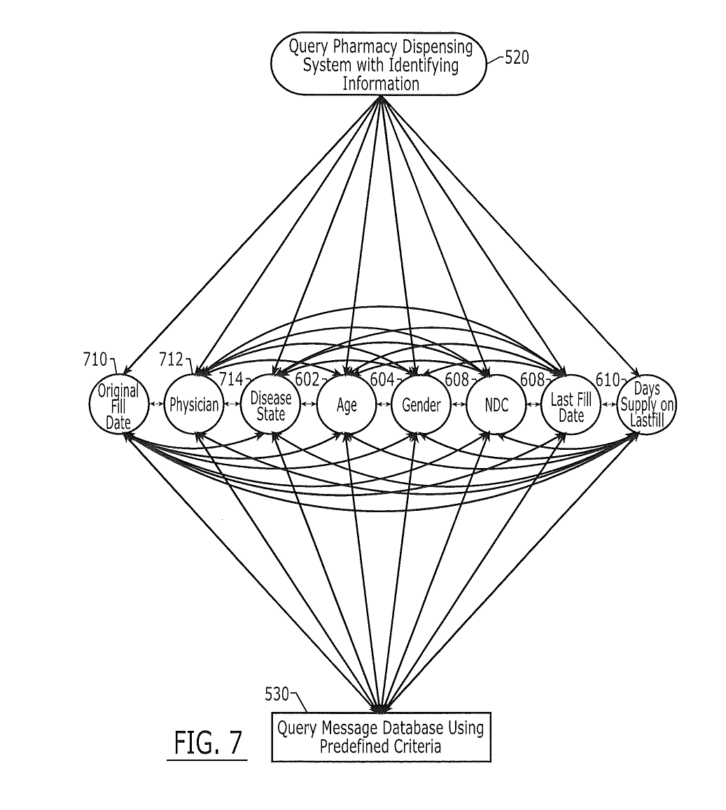

Returning again to FIG. 5, at Block 540, many types of predefined criteria may be used to query at least one database based on the identification of a pharmaceutical prescription, to thereby identify a targeted message to be displayed. In some embodiments, combinations and subcombinations of five criteria may be queried. In particular, as shown in FIG. 6, age 602, gender 604, NDC (medication) 606, last fill date 608 and/or days supply on last fill 610 may be queried in order to query at least one database using predefined criteria at Block 530. In some embodiments, the business rules can represent multiple qualifying and/or disqualifying NDCs 606. For example, if a diabetic patient is taking Glucophage (metformin hydrochloride) and Lantis (insulin), then display a given targeted message. Moreover, gender 604 may be inferred. Other criteria, such as zip code or location, also may be used. FIG. 7 illustrates eight criteria including combinations and subcombinations of original fill date 710, physician 712 and disease state 714, in addition to criteria 602-610 of FIG. 6, which may be used to query at least one database using the predefined criteria at Block 530. A co-morbidity qualifier also may be provided, in addition to, or instead of disease state 714, in some embodiments. Other combinations and subcombinations of these and/or other criteria may be used.

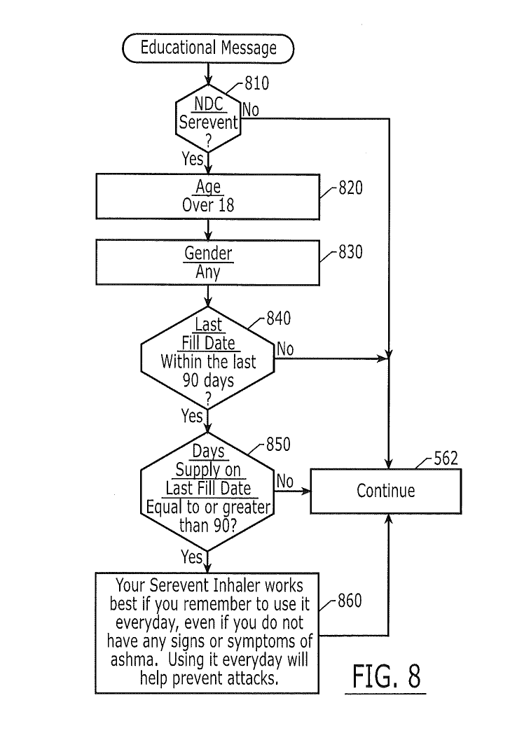

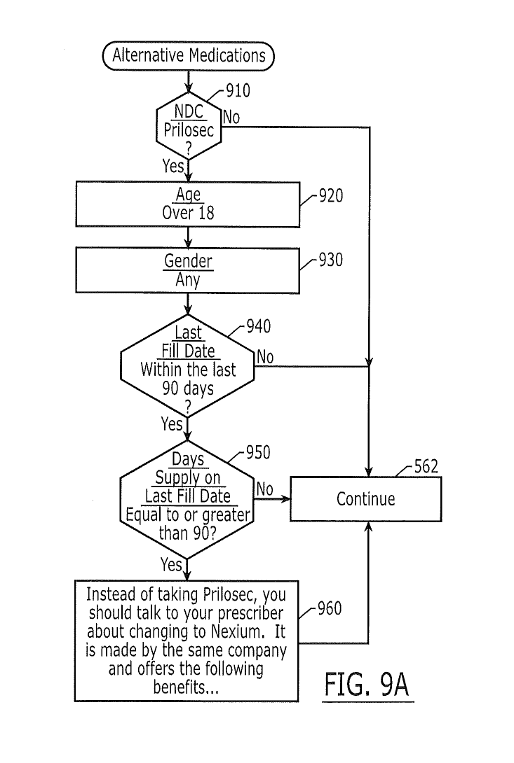

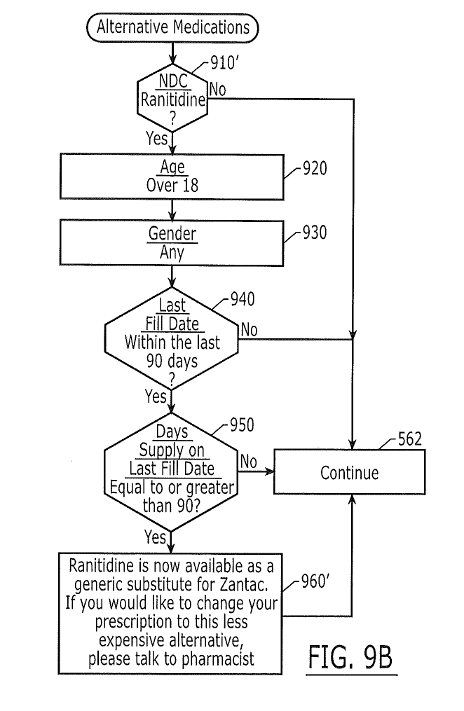

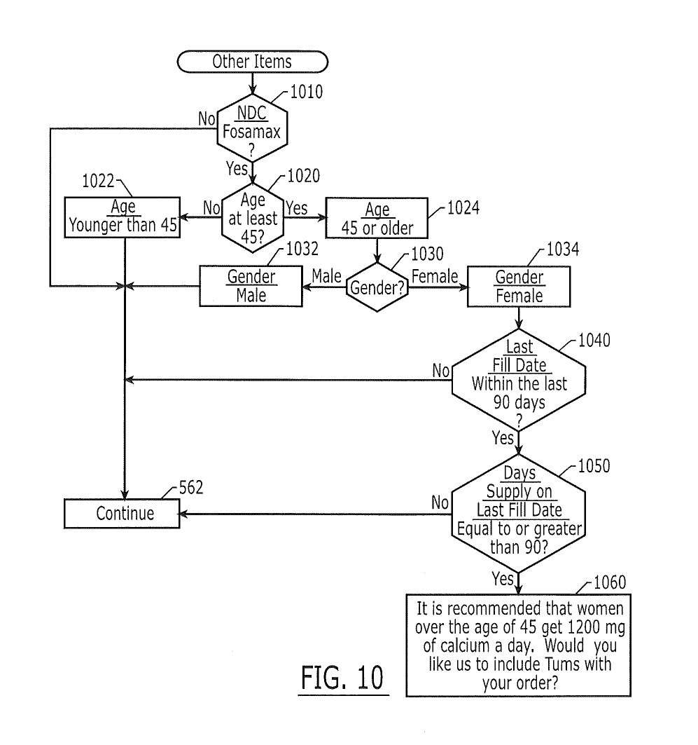

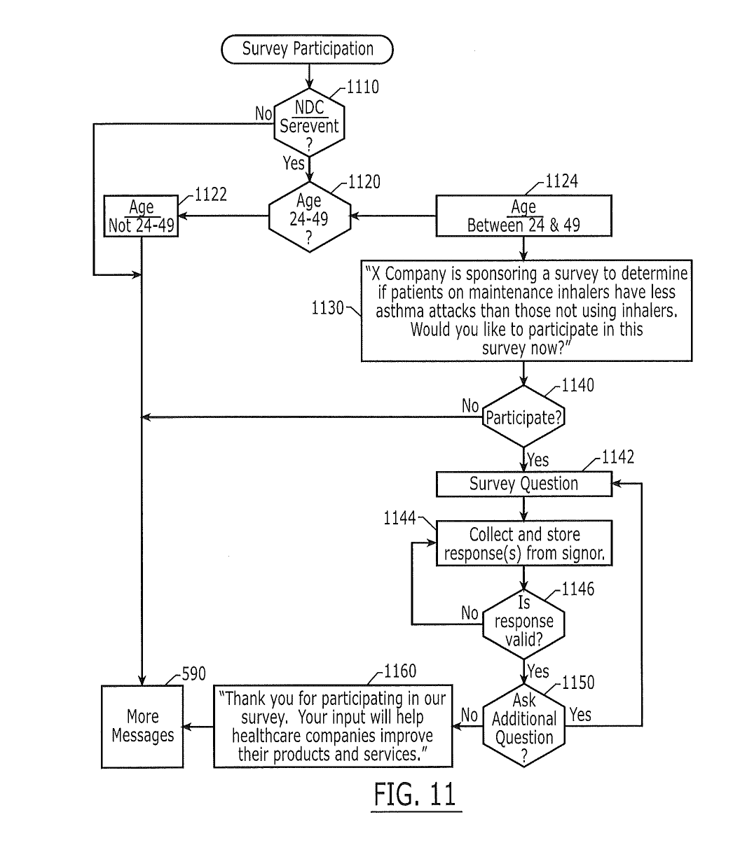

FIGS. 8-11 provide examples of targeted messages that may be generated based on querying at least one database using predefined criteria based on the identification of a pharmaceutical prescription to identify a targeted message, according to some embodiments of the present invention. These examples are illustrative and shall not be construed as limiting. Operations of these Figures may correspond to Blocks 520-560 of FIG. 5 and/or Blocks 230-250 of FIGS. 2 and 3. In particular, FIG. 8 will describe educational messages concerning the pharmaceutical prescription, FIGS. 9A and 9B will describe targeted messages that indicate alternative medications that may be substituted for the pharmaceutical prescription (“switching”), FIG. 10 will describe a targeted message that identifies other (related and/or unrelated) items that may be desired (“upselling”) and FIG. 11 will describe a targeted message that solicits participation in a study related to the pharmaceutical prescription (“research/survey”). Example display screens also will be provided.

Referring to FIG. 8, operations that may be performed to provide an educational message concerning the pharmaceutical prescription, according to some embodiments of the present invention, now will be described. As shown in FIG. 8, the following queries may be made to identify a targeted message matching the predefined criteria: At Block 810, a test is made as to whether the NDC (medication) corresponds to Serevent. If yes, at Block 820, age over 18, and at Block 830, any gender, may satisfy the criteria. At Block 840, a test is made as to whether the last fill date is within the last 90 days (or another first threshold) and at Block 850, a test is made as to whether the days supply on the last fill date is equal to or greater than 90 (or another second threshold which may or may not equal the first threshold).

If the tests of Blocks 810, 840 or 850 fail, then the operations continue at Block 562, including testing relative to other sets of predetermined criteria. However, if these tests pass, then a targeted message is displayed at Block 860 to display, “Your Serevent inhaler works best if you remember to use it every day, even if you do not have any signs or symptoms of asthma. Using it every day will help prevent attacks.” Thus, in FIG. 8, if a sufficient number of days of supply of the medication remain, the user is reminded to take the medication every day. An educational message is thereby provided. Accordingly, FIG. 8 illustrates embodiments of the present invention wherein at least one database is queried using a predefined criteria of last fill date and days supply on last fill date, based on the identification of a pharmaceutical prescription and identifying an educational target message that reminds the patient how to use the pharmaceutical prescription if the last fill date is less than a first threshold and the days supply on last fill date exceeds a second threshold which may or may not equal the first threshold. It also will be understood that in other embodiments, other predefined criteria may be used to provide an educational targeted message related to the pharmaceutical prescription.

FIGS. 9A and 9B illustrate embodiments of the present invention, which can provide targeted messages that indicate alternative medications that may be substituted for the pharmaceutical prescription, i.e., a targeted message that can advise on switching to a different drug, also referred to as “brand transition”. In particular, referring to FIG. 9A, at Block 910, a test is made as to whether the NDC is Prilosec. At Block 920, age over 18 may be identified and, at Block 930, any gender may be identified. At Block 940, if the last fill date is within the last 90 days and, at Block 950, if the days supply on the last fill date is equal to or greater than 90 days, then at Block 960, a message may be displayed that states, “Instead of taking Prilosec, you should talk to your prescriber about changing to Nexium. It is made by the same company and offers the following benefits . . . .” Alternatively, if the tests of Blocks 910, 940 and 950 are not satisfied, then the operations may be continued at Block 562.

FIG. 9B illustrates similar operations for the drug Ranitidine at Block 910′. At Block 960′, a message may be displayed that, “Ranitidine is now available as a generic substitute for Zantac. If you would like to change your prescription to this less expensive alternative, please talk to the pharmacist.” Accordingly, FIGS. 9A and 9B illustrate querying at least the database using predefined criteria of a last fill date and days supply on last fill date based on the identification of a pharmaceutical prescription, and identifying a targeted message that indicates alternative medications that may be substituted for the pharmaceutical prescription if the last fill date is less than a first threshold and the days supply on last fill date exceeds a second threshold, which may or may not be equal to the first threshold. It also will be understood that other predetermined criteria may be used to provide switching targeted messages, in other embodiments.

FIG. 10 is a flowchart of operations that may be performed to provide targeted messages regarding other items, also referred to as upselling, according to some embodiments of the present invention. The other items may include over-the-counter medications, supplies and/or other retail sales and add-on purchases, which may be related and/or unrelated to the prescribed product. At Block 1010, if the NDC (medication) is Fosamax, a test is made at Block 1020 as to whether age is at least 45. If the NDC is not Fosamax at Block 1010, or age is younger than 45 at Block 1022, then the prescription refill call flow may be continued at Block 562. However, if age is at least 45 at Block 1024, then at Block 1030, a test is made as to gender. If gender is male at Block 1032, then the prescription refill call flow may be continued at Block 562. However, if gender is female at Block 1034, then a test is made at Block 1040 as to whether the last fill date is within the last 90 days, and at Block 1050, as to whether the days supply on the last fill date is equal to or greater than 90 days. If these tests are passed, then at Block 1060, a targeted message is displayed stating, “It is recommended that women over the age of 45 get 1200 mg of calcium a day. Would you like us to include Tums with your order?”. Accordingly, FIG. 10 illustrates embodiments of the present invention wherein if the gender is female, the age exceeds a first threshold, last fill date is less than a second threshold (which may or may not equal the first threshold) and days supply on the last fill date exceeds a third threshold (which may or may not equal the first and/or second thresholds), a targeted message is identified that indicates other items that may be desired. These embodiments can include a query of NDC, age, gender, last fill date and days supply on last fill date. It also will be understood that other predetermined criteria may be used to provide upselling targeted messages in other embodiments.

FIG. 11 is a flowchart of other embodiments of the present invention that may be used to provide a targeted message that solicits participation in a survey related to the pharmaceutical prescription and/or allows the patient to actually participate in the survey. It will be understood that, as used herein, a survey can be a clinical trial, a brief survey and/or other study that is conventionally used in the pharmaceutical industry.

Referring now to FIG. 11, at Block 1110, a test is made as to whether the medication is identified as Serevent. At Block 1120, a test is made as to whether the age is between 24 and 49. If the tests at Blocks 1110 or 1120 fail, the prescription call flow may continue at Block 590. On the other hand, if at Block 1124 the age is between 24 and 49, then a targeted message may be displayed, at Block 1130, that indicates that a company is sponsoring a survey and asking if the patient would like to participate in a survey. At Block 1140, if the participant indicates that the patient wishes to participate, then at Block 1142, a survey question is asked. It will be understood by those having skill in the art that the question at Block 1140 may be asked to satisfy compliance rules for participation in the survey.

Continuing with the description of FIG. 11, at Block 1144, one or more responses are collected from the patient and tested for validity, at Block 1146. The response(s) may be stored. At Block 1150, if there are additional questions to ask, then the operations of Blocks 1142, 1144 and 1146 are repeatedly performed until there are no additional questions to ask. Once there are no additional questions to ask at Block 1150, a message may be displayed at Block 1160 that thanks the patient for participating in the survey. Accordingly, operations of FIG. 11 may be used to determine whether the age and/or gender qualifies the patient to participate in a study related to the pharmaceutical prescription and to identify a target message that solicits participation of the patient in the study related to the pharmaceutical prescription if the age and/or gender of the patient qualifies the patient to participate. Additional operations may be performed to display messages to the patient, to complete the study related to the pharmaceutical prescription. It also will be understood that other predetermined criteria may be used to solicit study participation in other embodiments.

Another embodiment of FIG. 11 now will be described. In these embodiments, rather than soliciting participation in a survey, participation in a clinical research study is solicited. Thus, in these embodiments, at Block 1110, the NDC is metformin hydrochloride, and at Block 1130, the display may read “There is a clinical research opportunity being conducted in your area for Type 2 diabetes. If you have had trouble controlling your blood glucose levels and are interested in learning more about the study opportunity, press ‘Accept’, otherwise press ‘Decline’.” In some embodiments, prior to, concurrent with and/or after providing the display of Block 1130, a display about the study sponsor's privacy policy, which may be different from general HIPPA requirements, may be provided. At Block 1142, additional questions may be asked, to further prequalify a patient candidate. For example, at Block 1142, a question may be displayed “Are you currently taking Celebrex?”, and a response may be collected from the patient at Block 1144. Additional questions may be displayed at Block 1150 if desirable. For example, at Block 1150, an additional question can be displayed: “If you are interested in receiving a phone call about the clinical study, press ‘Accept’, otherwise ‘Decline’.” Finally, at Block 1160, a message can be displayed stating “Thank you for your interest in this study. You will be called.” Accordingly, embodiments of FIG. 11 may also be used to solicit study participation.

Additional discussion of various embodiments of the present invention now will be provided. Some embodiments of the invention provide systems, methods and/or computer program products wherein, based on defined criteria including the treated patient's prescription medication(s) and associated applied business rules, the patient/caregiver candidate (defined as such, until either an opt-in or enrolled status is obtained) is presented in real time, targeted information via the electronic signature capture device at the pharmacy point of care. Embodiments of the present invention can be technology independent.

The logic and applied business rules can determine which patient candidates receive what presentment message. The business rules can include patient and/or medication attributes. In other embodiments, the business rules can include location (such as zip code), prescribing physician and payor information. The presentment message may contain static (branded/nonbranded) information, disease education, clinical research opportunities, dynamic information based on survey results, compliance and persistency programs, enrollment for medication refills, raise awareness, and many other displayed messages.

In some embodiments, the presentment message may represent ethnic diversity by language support. In other embodiments, the presentment message can be age and time of day appropriate. The messages may be reviewed for regulatory and legal efficacy by the appropriate governing body.

In some embodiments, Protected Health Information (PHI) or Personal Information (PI) need not be compromised. There can be effective controls regarding HIPPA and related security rules for both access control and entity authentication.

The signor may be provided with the information to determine if the signor is interested in receiving the information (opt-in) or the signor may decline the message. The patient candidate can acknowledge an interest by using the electronic signature capture device. The prompts may be displayed on the screen footprint with the designer's perspective for readability.

In some embodiments, the patient candidate's responses are captured and encrypted and stored in a deidentified format. Opt-in responses may be excluded per the project protocol on a per business case basis. The electronic signature capture device may also operate on a time out basis in some embodiments, so that after the elapsed time has passed all information including the presentment activity can be replaced with a generic pharmacy message on the device display. The electronic signature capture device may be a stand alone unit or an integrated multipurpose unit. In some embodiments, the normal flow of the pharmacy transaction may be resumed without disruption at the point of opt-in acknowledgement or a message to client response. The treated patient's signature may be obtained on the electronic signature device for pharmacy prescription pick up, HIPPA acknowledgment, opt-in acknowledgment demonstrative of interest and participation and/or for any other purposes.

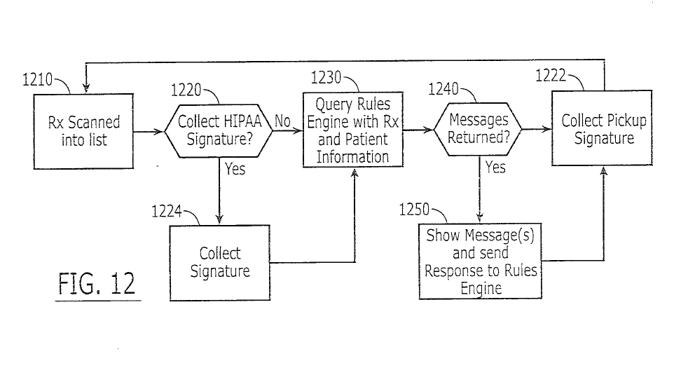

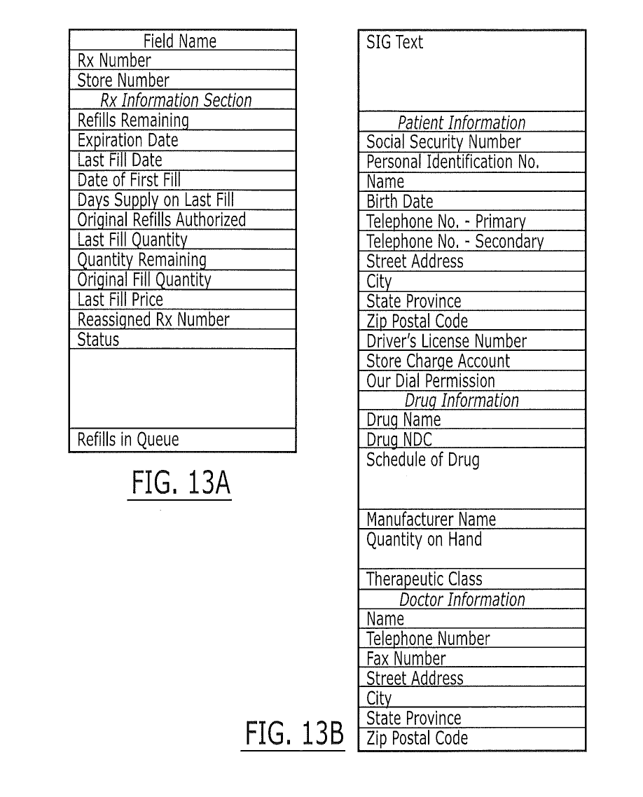

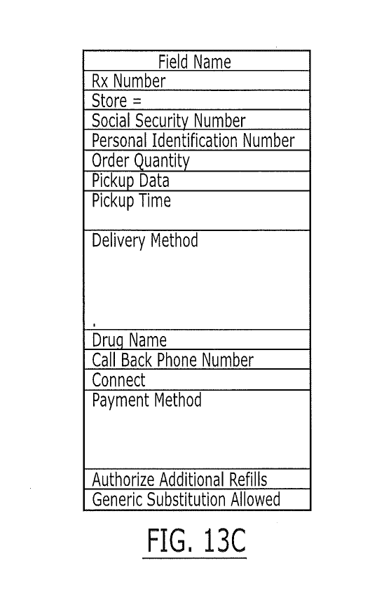

FIG. 12 is a flowchart of operations that may be performed to display targeted messages in connection with HIPPA signature collection and prescription pick up, according to some embodiments of the present invention. Referring to FIG. 12, as shown at Block 1210, a prescription identification is scanned into a list, which may correspond to the operations at Block 210 as described above. At Block 1220 it may be desirable to collect a HIPPA signature and if so, at Block 1224 the HIPPA signature is accepted, which may correspond to Block 220 described above. At Block 1230 the rules engine is queried, which may correspond to Block 230 described above. If a message is identified at Block 1240, which may correspond to Block 240 described above, then messages are displayed at Block 1250, which may correspond to Block 250 described above. A pick up signature 1222 may then be obtained at Block 1222. Accordingly, in embodiments of FIG. 12, messages may be displayed after a HIPPA signature is collected at Block 1220 but before a pick up signature is collected at Block 1222. Additional generic messages may be displayed during a screen saver. In querying a rules engine with the prescription and patient information at Block 1230, the treated patient caregiver may be identified by a single attribute or combination of attributes as shown in FIGS. 13A, 13B and/or 13C. The field names are representative of information that may be present at the time of transaction but shall not be construed as limiting. The field names of FIGS. 13A-13C may correspond to the databases in the pharmacy dispensing system 535 of FIG. 5.

### EXAMPLE

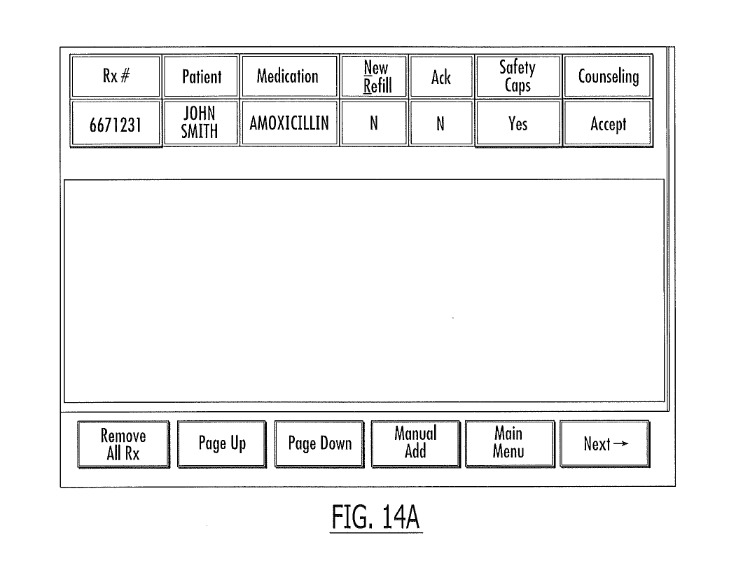

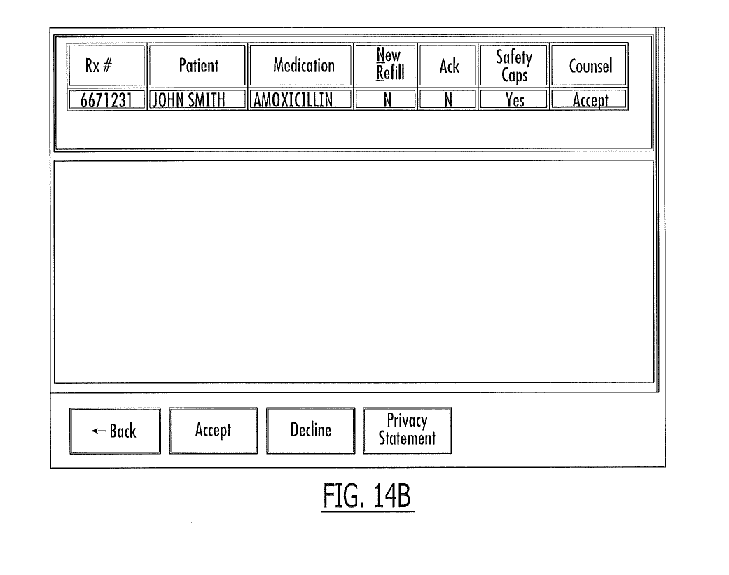

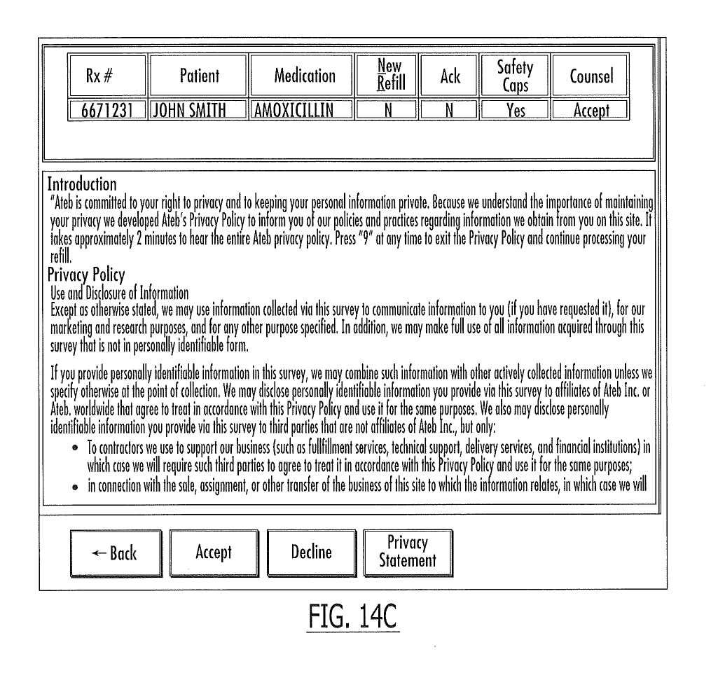

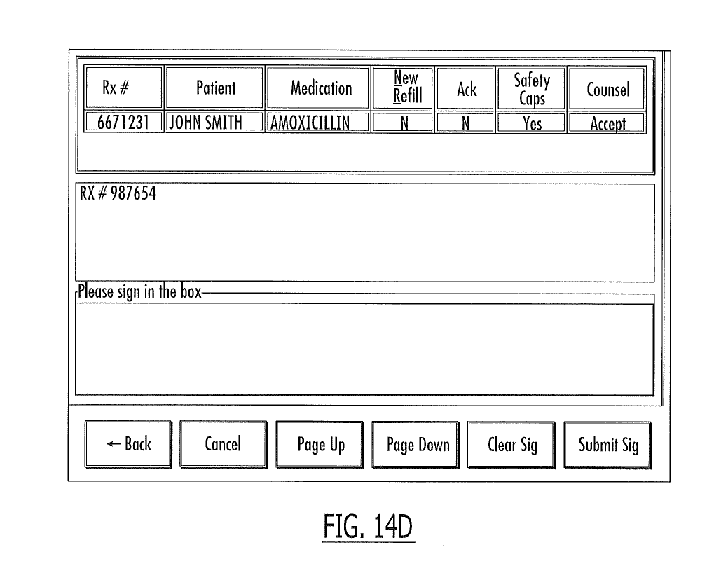

The following example shall be regarded as merely illustrative and shall not be construed as limiting the invention. This example will illustrate enrolling sample patients into a marketing programs using two messaging opportunities to improve participation, and may correspond to the operations that were generally described in FIG. 11. The process flow in the pharmacy at the point of customer prescription pickup may be as follows:
Step 1 Customer goes to the normal prescription pick up counter to pick up a requested prescription.
Step 2 Pharmacy retrieves the prescription per normal practices.
Step 3 The prescription number is scanned or manually entered at the signature capture station.
Step 4 The prescription information is displayed. See FIG. 14A.
Step 5 If one or more of the customers' acknowledgments has not been obtained, then the following will occur:
   A screen is displayed to capture the customer's signature for acknowledgment.
   The pharmacy associate shows the customer the pharmacy's privacy policy.
   The customer or representative of the customer signs to acknowledge that they have been provided the privacy policy.
   The date, time, acknowledgment version, and signature are saved electronically.
Step 6 Based on the business rules; (e.g., patient is 18 yrs or older, prior presentment), the marketing campaign messaging is displayed for customer opt-in. Message presentment may be a maximum of 2× per patient.
Step 7 The customer is presented with the option to participate in the program with the following message text displayed on the screen of FIG. 14B:
   Would you be interested in enrolling in a FREE patient education program that entitles you to acid reflux disease news, tips on nutrition and lifestyle choices to help manage heartburn, and discounts on your prescription? If you enroll, you will receive ongoing mailings with information about acid reflux disease, in addition to money-saving offers on your prescription.
   Would you like us to automatically enroll you into the program? Press Accept (#) to enroll now, otherwise (#) to Decline. To read our full Privacy Policy regarding the use of information we collect during this program, press Privacy Statement.
Step 8 If the customer pressed Privacy Statement, the customer is presented with the Privacy Policy Notice of FIG. 14C.
Step 9 The customer signs the third party disclaimer for all of the prescriptions using the screen of FIG. 14D.
Step 10 The information for each prescription along with the customer's signature is saved.
Step 11 The pharmacy associate completes the transaction; e.g., rings the prescription up at the point of sale, receives payment, and hands the customer their prescription. If patient chooses to opt in the marketing campaign, the patient address information is automatically collected from the pharmacy system and provided to marketing who will fulfill this request via U.S. Mail.

Embodiments of the invention have described the display of targeted messages on a signature capture system. In other embodiments, targeted messages also may be provided as part of the interactive voice response system 120 as described in application Ser. No. 10/672,556 to DiVenuta et al. entitled Methods, Systems and Computer Program Products for Providing Targeted Messages for Pharmacy Interactive Voice Response (IVR) Systems, filed Sep. 25, 2003 assigned to the assignee of the present application, the disclosure of which is hereby incorporated in its entirety as if set forth fully herein.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method of operating a pharmacy comprising:
accepting identification of a pharmaceutical prescription during a pharmacy transaction;
accepting a signature on a signature capture system during the pharmacy transaction;
querying at least one database with a processor using predefined criteria based on the identification of a pharmaceutical prescription to identify a targeted message; and
displaying the targeted message on the signature capture system during the pharmacy transaction.

2. A method according to claim 1 wherein accepting identification of a pharmaceutical prescription comprises:
accepting a bar code scan of a bar code on a container that corresponds to the pharmaceutical prescription during the pharmacy transaction;
accepting input of a pharmaceutical prescription number that corresponds to the pharmaceutical prescription during the pharmacy transaction; and/or
accepting input of identification information that can be used to identify the pharmaceutical prescription during the pharmacy transaction.

3. A method according to claim 1 wherein accepting a signature comprises:
accepting a signature on a signature capture system to acknowledge pharmaceutical prescription receipt, to acknowledge Health Insurance Portability & Accountability Act (HIPAA) information receipt, to acknowledge credit card/debit card payment and/or to acknowledge a desire to receive the targeted message.

4. A method according to claim 1 wherein the signature capture system includes a signature capture touch screen and wherein displaying the targeted message is performed on the signature capture touch screen.

5. A method according to claim 1 wherein the signature capture system includes a signature capture touch screen and an instructions screen and wherein displaying the targeted message is performed on the signature capture touch screen and/or on the instructions screen.

6. A method according to claim 1 further comprising:
removing the targeted message from display on the signature capture system after expiration of a timer.

7. A method according to claim 1 wherein displaying the targeted message comprises:
displaying the targeted message on the signature capture system in response to accepting the signature on the signature capture system during the pharmacy transaction.

8. A method according to claim 1 wherein querying comprises:
querying at least one database using the predefined criteria based on the identification of a pharmaceutical prescription to identify a series of targeted messages; and
wherein the displaying comprises displaying a succeeding one of the series of targeted messages on the signature capture system in response to receipt of a response on the signature capture system to a preceding one of the series of targeted messages.

9. A method according to claim 1 further comprising:
receiving a response to the targeted message on the signature capture system.

10. A method according to claim 9 further comprising:
logging the response.

11. A method according to claim 9 further comprising:
instructing the pharmacy to perform an action in response to the response to the targeted message.

12. A method according to claim 1 wherein the predefined criteria based on the identification of a pharmaceutical prescription comprise age of a patient who is using the pharmaceutical prescription, gender of the patient, medication of the pharmaceutical prescription, last fill date of the pharmaceutical prescription, days supply on last fill of the pharmaceutical prescription, original fill date of the pharmaceutical prescription, disease state of the patient, physician of the patient and/or other promotions in effect.

13. A method according to claim 1 wherein the predefined criteria based on the identification of a pharmaceutical prescription do not include a personal identification of a patient who is using the pharmaceutical prescription.

14. A method according to claim 1 wherein the predefined criteria based on the identification of a pharmaceutical prescription comprise age of the patient, gender of the patient, medication of the pharmaceutical prescription, last fill date of the pharmaceutical prescription, days supply on last fill of the pharmaceutical prescription, original fill date of the pharmaceutical prescription, disease state of the patient, physician of the patient and/or other promotions in effect, but do not include a personal identification of a patient who is using the pharmaceutical prescription.

15. A method according to claim 1 wherein querying comprises:
querying at least one database using age of a patient who is using the pharmaceutical prescription, gender of the patient, medication of the pharmaceutical prescription, last fill date of the pharmaceutical prescription, days supply on last fill of the pharmaceutical prescription, original fill date of the pharmaceutical prescription, disease state of the patient, physician of the patient and/or other promotions in effect, based on the identification of a pharmaceutical prescription; and
identifying a targeted message that corresponds to the age of the patient, gender of the patient, medication of the pharmaceutical prescription, last fill date of the pharmaceutical prescription, days supply on last fill of the pharmaceutical prescription, original fill date of the pharmaceutical prescription, disease state of the patient, physician of the patient and/or other promotions in effect.

16. A method according to claim 1 wherein the targeted message comprises an educational message concerning the pharmaceutical prescription, a message that indicates alternative medications that may be substituted for the pharmaceutical prescription, a message that identifies other items that may be desired and/or a message that solicits participation in a survey related to the pharmaceutical prescription.

17. A method according to claim 1 wherein querying comprises querying at least one database using the predefined criteria based on the identification of the pharmaceutical prescription to identify an educational targeted message concerning the pharmaceutical prescription.

18. A method according to claim 1 wherein querying comprises:
querying at least one database using predefined criteria of last fill date and days supply on last fill date based on the identification of a pharmaceutical prescription; and
identifying an educational targeted message that displays how to use the pharmaceutical prescription if the last fill date is less than a first threshold and the days supply on last fill date is greater than a second threshold.

19. A method according to claim 1 wherein querying comprises:
querying at least one database using predefined criteria of last fill date and days supply on last fill date based on the identification of a pharmaceutical prescription; and
identifying a targeted message that indicates alternative medications that may be substituted for the pharmaceutical prescription if the last fill date is less than a first threshold and the days supply on last fill date exceeds a second threshold.

20. A method according to claim 1 wherein querying comprises:
querying at least one database using predefined criteria of age, gender, last fill date and days supply on last fill date based on the identification of a pharmaceutical prescription; and
identifying a targeted message that indicates other items that may be desired if the gender is female, the age exceeds a first threshold, last fill date is less than a second threshold and days supply on last fill date exceed a third threshold.

21. A method according to claim 1 wherein querying comprises:
querying at least one database using a predefined criterion of age of a patient who is using the pharmaceutical prescription based on the identification of a pharmaceutical prescription; and
identifying a targeted message that that solicits participation of the patient in a survey related to the pharmaceutical prescription if the age of the patient qualifies the patient to participate in the survey related to the pharmaceutical prescription.

22. A method according to claim 21 further comprising:
providing additional targeted messages to allow the patient to participate in the survey if the patient agrees to participate.

23. A method according to claim 1 wherein querying comprises:
querying at least one pharmacy dispensing system database using the identification of the pharmaceutical prescription to identify the predetermined criteria; and
querying at least one message database using the predetermined criteria to identify a targeted message.

24. A method according to claim 1 wherein the identification of a pharmaceutical prescription is an Rx number.

25. A pharmacy management system, the system comprising:
means for accepting identification of a pharmaceutical prescription during a pharmacy transaction;
means for accepting a signature on a signature capture system during the pharmacy transaction;
means for querying at least one database using predefined criteria based on the identification of a pharmaceutical prescription to identify a targeted message; and
means for displaying the targeted message on the signature capture system during the pharmacy transaction.

26. A pharmacy management system program product, the computer program product comprising computer program code embodied in a non-transitory computer-readable medium, the computer program code comprising:
computer readable program code configured to accept identification of a pharmaceutical prescription during a pharmacy transaction;
computer readable program code configured to accept a signature on a signature capture system during the pharmacy transaction;
computer readable program code configured to query at least one database using predefined criteria based on the identification of a pharmaceutical prescription to identify a targeted message; and
computer readable program code configured to display the targeted message on the signature capture system during the pharmacy transaction.

27. A method of operating a pharmacy in response to accepting a signature on a signature capture system during a pharmacy transaction, the method comprising:
identifying, with a processor, a targeted message for display on the signature capture system using predefined criteria that are based on an identification of a pharmaceutical prescription that is associated with the signature that is accepted.

28. A method according to claim 27 wherein the identification of a pharmaceutical prescription is obtained by:
accepting a bar code scan of a bar code on a container that corresponds to the pharmaceutical prescription;
accepting input of a pharmaceutical prescription number that corresponds to the pharmaceutical prescription; and/or
accepting input of identification information that can be used to identify the pharmaceutical prescription.

29. A method according to claim 27 wherein accepting a signature comprises:
accepting a signature on a signature capture system to acknowledge pharmaceutical prescription receipt, to acknowledge Health Insurance Portability & Accountability Act (HIPAA) information receipt, to acknowledge credit card/debit card payment and/or to acknowledge a desire to receive the targeted message.

30. A method according to claim 27 wherein the signature capture system includes a signature capture touch screen and wherein identifying a targeted message for display on the signature capture system comprises identifying a targeted message for display on the signature capture system touch screen.

31. A method according to claim 27 wherein the signature capture system includes a signature capture touch screen and an instructions screen and wherein identifying a targeted message for display on the signature capture system comprises identifying a targeted message for display on the signature capture system touch screen and/or on the instructions screen.

32. A method according to claim 27 further comprising:
removing the targeted message from display on the signature capture system after expiration of a timer.

33. A message according to claim 27 wherein identifying is followed by:
displaying the targeted message on the signature capture system.

34. A method according to claim 27 wherein identifying comprises:
identifying a series of targeted messages for display on a signature capture system using predefined criteria that are based on an identification of a pharmaceutical prescription that is associated with the signature that is captured.

35. A method according to claim 33 further comprising:
receiving a response to the targeted message on the signature capture system.

36. A method according to claim 35 further comprising:
logging the response.

37. A method according to claim 35 further comprising:
instructing the pharmacy to perform an action in response to the response to the targeted message.

38. A method according to claim 27 wherein the predefined criteria that are based on the identification of a pharmaceutical prescription comprise age of a patient who is using the pharmaceutical prescription, gender of the patient, medication of the pharmaceutical prescription, last fill date of the pharmaceutical prescription, days supply on last fill of the pharmaceutical prescription, original fill date of the pharmaceutical prescription, disease state of the patient, physician of the patient and/or other promotions in effect.

39. A method according to claim 27 wherein the predefined criteria that are based on the identification of a pharmaceutical prescription do not include a personal identification of a patient who is using the pharmaceutical prescription.

40. A method according to claim 27 wherein the predefined criteria that are based on the identification of a pharmaceutical prescription comprise age of a patient who is using the pharmaceutical prescription, gender of the patient, medication of the pharmaceutical prescription, last fill date of the pharmaceutical prescription, days supply on last fill of the pharmaceutical prescription, original fill date of the pharmaceutical prescription, disease state of the patient, physician of the patient and/or other promotions in effect, but do not include a personal identification of a patient who is using the pharmaceutical prescription.

41. A method according to claim 27 wherein identifying comprises:
querying at least one database using age of a patient who is using the pharmaceutical prescription, gender of the patient, medication of the pharmaceutical prescription, last fill date of the pharmaceutical prescription, days supply on last fill of the pharmaceutical prescription, original fill date of the pharmaceutical prescription, disease state of the patient, physician of the patient and/or other promotions in effect, based on the identification of a pharmaceutical prescription; and
identifying a targeted message that corresponds to the age of the patient, gender of the patient, medication of the pharmaceutical prescription, last fill date of the pharmaceutical prescription, days supply on last fill of the pharmaceutical prescription, original fill date of the pharmaceutical prescription, disease state of the patient, physician of the patient and/or other promotions in effect.

42. A method according to claim 27 wherein the targeted message comprises an educational message concerning the pharmaceutical prescription, a message that indicates alternative medications that may be substituted for the pharmaceutical prescription, a message that identifies other items that may be desired and/or a message that solicits participation in a survey related to the pharmaceutical prescription.

43. A method according to claim 27 wherein identifying comprises querying at least one database using the predefined criteria that are based on the identification of the pharmaceutical prescription to identify an educational targeted message concerning the pharmaceutical prescription.

44. A method according to claim 27 wherein identifying comprises:
querying at least one database using predefined criteria of last fill date and days supply on last fill date that are based on the identification of a pharmaceutical prescription; and
identifying an educational targeted message that displays how to use the pharmaceutical prescription if the last fill date is less than a first threshold and the days supply on last fill date is greater than a second threshold.

45. A method according to claim 27 wherein identifying comprises:
querying at least one database using predefined criteria of last fill date and days supply on last fill date that are based on the identification of a pharmaceutical prescription; and
identifying a targeted message that indicates alternative medications that may be substituted for the pharmaceutical prescription if the last fill date is less than a first threshold and the days supply on last fill date exceeds a second threshold.

46. A method according to claim 27 wherein identifying comprises:
querying at least one database using predefined criteria of age, gender, last fill date and days supply on last fill date that are based on the identification of a pharmaceutical prescription; and
identifying a targeted message that indicates other items that may be desired if the gender is female, the age exceeds a first threshold, last fill date is less than a second threshold and days supply on last fill date exceed a third threshold.

47. A method according to claim 27 wherein identifying comprises:
querying at least one database using a predefined criterion of a patient who is using the pharmaceutical prescription that is based on the identification of a pharmaceutical prescription; and
identifying a targeted message that solicits participation of the patient in a survey related to the pharmaceutical prescription if the age of the patient qualifies the patient to participate in the survey related to the pharmaceutical prescription.

48. A method according to claim 47 further comprising:
providing additional targeted messages to allow the patient to participate in the survey if the patient agrees to participate.

49. A method according to claim 27 wherein identifying comprises:
querying at least one pharmacy dispensing system database using the identification of the pharmaceutical prescription to identify the predetermined criteria; and
querying at least one message database using the predetermined criteria to identify a targeted message.

50. A method according to claim 27 wherein the identification of a pharmaceutical prescription is an Rx number.

51. A pharmacy management system, the system comprising:
means for identifying a targeted message for display on the signature capture system using predefined criteria that are based on an identification of a pharmaceutical prescription that is associated with the signature that is accepted; and
means for displaying the targeted message on the signature capture system.

52. A pharmacy management computer program product, the computer program product comprising computer program code embodied in a non-transitory computer-readable medium, the computer program code comprising:
computer program code configured to identify a targeted message for display on the signature capture system using predefined criteria that are based on an identification of a pharmaceutical prescription that is associated with the signature that is accepted.
